(19) United States
(12) Patent Application Publication
(10) Pub. No.: US 2026/0253470 A1
(43) Pub. Date: Aug. 27, 2026

(54) THERMAL IMAGING FOR ROOM-LEVEL REAL-TIME LOCATION SERVICE

(71) Applicants: HID Global Corp., Austin, TX (US); ASSA ABLOY AB, Stockholm (SE)

(72) Inventors: Robert Kjell Rowe, Poulsbo, WA (US); Srinjay Paul, Albuquerque, NM (US); Mark Robinton, Eden Prairie, MN (US); Matthew Johnson, Parkland, FL (US)

(21) Appl. No.: 18/875,813

(22) PCT Filed: Jun. 23, 2022
(86) PCT No.: PCT/US2022/073110

§ 371 Date: Dec. 17, 2024

(51) Int. Cl. G07C 9/38; G01S 5/02; G06V 10/764; G06V 10/82; G06V 20/52; G06V 40/10

(52) U.S. Cl. CPC G07C 9/38; G01S 5/0264; G06V 10/764; G06V 10/82; G06V 20/53; G06V 40/10

(57) ABSTRACT

A method of operating a real-time location services (RTLS) system includes obtaining, by a processing device of the RTLS system, location information identifying an object or person and a building-area location of the object or person; obtaining, by the processing device, access-event information of a access of a physical access portal associated with the building-area location; and matching the location information of the identified object or person and the access-event information and generating an indication of the building-area location of the object or person using the processing device in response to the matching.

### TECHNICAL FIELD

Embodiments illustrated and described herein generally relate to system architectures for real-time location services (RTLS).

### BACKGROUND

RTLS provides real time tracking to identify and track the location of people and objects. Some RTLS systems use radio frequency (RF) signals to track the location of people at a building-area level (e.g., a room-level). RF-based RTLS systems may be based on Bluetooth™ Low Energy (BLE), ultra-wideband (UWB), Wi-Fi, or other RF technologies. For example, in a hospital environment, patients, staff, and equipment may be fitted with BLE beacons whose signals are then detected by one or more beacon receivers. RTLS can be used to assist with billing for services, evaluate productivity, locate shared resources, and other tasks.

Position estimates provided by RF-based RTLS systems may be adversely affected by multipath effects, attenuation of the signal by the human body and other objects, non-uniform signal reception, and a variety of other phenomena that affect RF signals. The resulting errors in the RTLS position estimates may be disruptive to the workflow and intended use for the RTLS information. The need for location accuracy may be compromised if errors in RTLS position estimates become great enough to cause spurious position estimates.

### BRIEF DESCRIPTION OF THE DRAWINGS

FIG. 1 is an illustration of portions of a real time location services (RTLS) system.

FIG. 2 is a flow diagram of an example of a method of operating an RTLS system.

FIG. 3 is a block diagram schematic of an example of portions of a processing device of an RTLS system.

FIGS. 4-5 are block diagram schematics of portions of further examples of a processing device.

### DETAILED DESCRIPTION

RTLS provides real time tracking to identify and track the location of people and objects over time. RTLS systems may be RF-based, but position estimates provided by RF-based RTLS systems may be adversely affected by a variety of phenomena that affect the RF signal(s). In general, an approach to increase RTLS location accuracy and reduce errors is to install an auxiliary sensing system that provides independent information about access events to the location. In this way if the RTLS system indicates that a beacon entered or exited a building area, the signal from the auxiliary system can be checked to see if it also indicated an access event at the same building-area location and at approximately the same time.

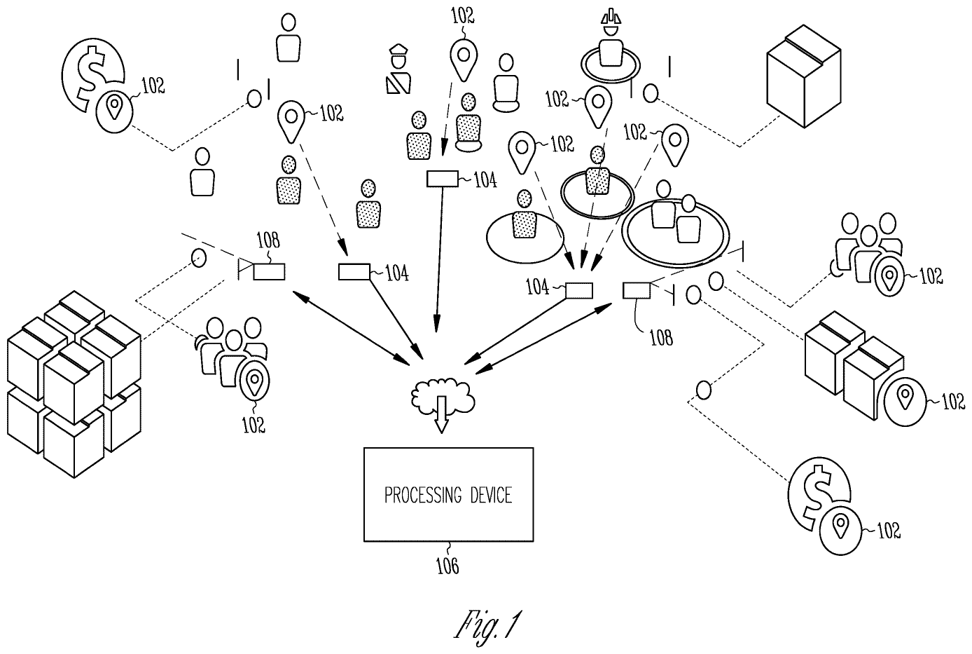

FIG. 1 is an illustration of portions of an RTLS system implemented in a building space. Some or all of the persons in the building wear beacon emitting devices 102 (e.g., beacon signal emitting badges or wrist bands). Beacon emitting devices 102 may also be attached to assets or other objects (e.g., an asset tracker such as an RFID device). The beacon emitting devices 102 emit a beacon signal. The beacon signal may be a BLE signal, an UWB signal, a Wi-Fi signal, or other RF technology signal. The beacon signal includes fields or packets of information. At least one field of the beacon signal includes information that identifies the person or object.

The building is divided into areas or locations (e.g., room-level locations). The locations of interest include a receiver device 104 (e.g., a fixed location beacon reading device, a gateway device, etc.) or are otherwise associated with a receiver device 104. The receiver devices 104 monitors the area looking for the beacon signals. When a receiver device 104 receives a beacon signal, the building-area location associated with the receiver device 104 is associated to the person or object identified by the beacon signal.

The system includes a beacon processing device 106. The processing device 106 tracks the building-area locations of the beacon emitting devices 102. The processing device 106 includes one or more hardware processors and memory. The memory includes computer readable instructions that when performed by the one or more hardware processors cause the one or more hardware processors to perform the functions described. In some examples, the processing device 106 is a server. The processing device 106 may be a central device (e.g., a server) that is located at the building or the processing device 106 can be a network attached device, such as a cloud-based server. Multiple receiver devices 104 may detect the beacon signal from the same beacon emitting device 102. The processing device 106 processes the indications from the multiple receiver devices to estimate the location of the beacon emitting device 102. The determined location may be a two-dimensional (2D) or three-dimensional (3D) coordinate in the building for the beacon emitting device 102 or may be an estimated region of the building (e.g., a room location) of the beacon emitting device 102.

The building-area locations can include one or more physical access portals to gain access to the location. A physical access portal may be a door, an aisle, a hallway, a building entrance, etc. To improve the accuracy of the RF-based RTLS, the system includes access event detectors 108 located at, near, or otherwise associated with the physical access portals that detect an access event at a portal (e.g., someone going through a door into the room). When the processing device 106 receives information identifying an object or person and a building-area location of the object or person, the processing device 106 confirms the location with an access event detected by an access event detector 108 at the building-area location. If the location information can be matched to an access event at the location, the confidence in the building-area location of the person or object increases.

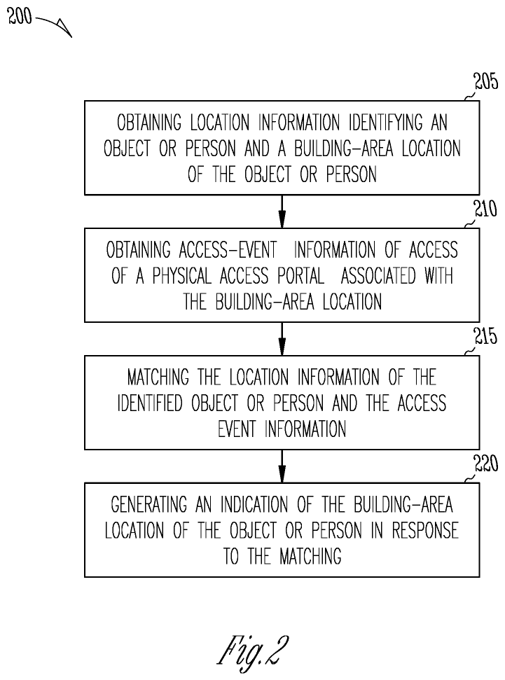

FIG. 2 is a flow diagram of an example of a method of operating an RTLS system, such as the RTLS system in the example of FIG. 1. The method 200 includes a technique to improve accuracy of RTLS. At block 205, the processing device 106 of the RTLS system obtains information identifying an object or person and a building-area location of the object or person. The processing device 106 may receive A beacon signal form one or more receiver devices 104. The processing device 106 processes the beacon signals to identify the beacon emitter device 102 sending the beacon signals. For example, the processing device 106 may decode an identifier included in the beacon signal. The processing device 106 also processes the beacon signals to estimate the position of the beacon emitting device 102 with some level of granularity.

In some examples, the processing device 106 performs a trilateration algorithm or other algorithm to generate an estimate of 2D (e.g., X, Y) or 3D (e.g., X, Y, Z) coordinates based on signal strength (e.g., a received signal strength indicator, or RSSI). The estimated coordinates may then be converted to a building-area estimate (e.g., a room estimate). In some examples, the location of the receiver device 104 indicating reception of the strongest version of the beacon signal, may be selected as the location the beacon is in; assuming there is at least one receiver device 104 in every building area of interest. In some examples, a region of the building may be ‘fingerprinted’ (i.e., measurements are taken that show the responses of the receiver device 104 or devices of the building region to a large number of beacon positions). The fingerprinting can be used in subsequent position estimates by finding the nearest match between the multiple receiver signals and the previously collected fingerprint data. In some examples, UWB signaling is used for the beacon signals. The radial distance from the beacon emitting device 102 to the receiver device 106 may be directly measured by the receiver device 104 through time-of-flight. UWB beacon signals from multiple receiver devices 104 may be combined to estimate the exact location of the beacon emitting device 102 and to reduce measurement noise.

At block 210, the processing device 106 obtains access-event information of access of a physical access portal associated with the building-area location. The processing device 106 may receive the access-event information from an access event detector 108. The access event detector 108 includes one or more sensors to detect access to the physical access portal. Some examples of an access event detector 108 include an infrared sensor or passive infrared (PIR) sensor, a light curtain sensor, or a thermal imager that detect an object physically passing through the portal. The access-event information may be a message indicating detection of an object passing through the portal and a timestamp of the detection. In some examples, the information may be a signal indicating detection of an object passing through the physical portal sent to the processing device 106 and the processing device 106 records the time of the detection. In some examples, the access-event information may be raw data that the processing device 106 processes to determine if an access-event occurred.

At block 215, the processing device 106 matches the location of the identified object or person and the access-event information. For example, if the processing device 106 receives information of a person identified and associated with Room X, the processing device 106 can check if the access event detector 108 detected someone entering Room X through a door to Room X. The processing device 106 may read events stored at the access event detector 108 for the building area in response to receiving the location information identifying the person and building-area location, or the access event detector 108 can send access-event information to the processing device 106 in response to the detected access event. In some examples, the receiver device 104 and the access event detector 108 are combined into one device. The combined beacon signal receiver and access detector sends the identity information and access detection information to the processing device 106.

If the processing device 106 can associate the identity and location information with an access event at the location the confidence in the building-area location of the person is increased. This associating may be as simple as determining there was a portal access event at the building-area location. In some examples, the identity and location information is associated with a portal access event if the time (e.g., determined using a timestamp) of the portal access event occurs within a specified time duration of the time of the identity and location information. In some examples, multiple portal access events are used to confirm the location information, such as by tracking progress of the person through multiple building-area locations and verifying the progress by detecting physical access through portals associated with the building-area locations.

In response to matching the location information using the access event as a second check of the location information, at block 220, the processing device 106 generates an indication of the building-area location of the object or person. The indication may be recording the location of the person (or object). In some examples, the indication is a transient alert of someone being at the location. In some examples, the access-event information confirms the location information and only confirmed location and identity information is used to assist with optimizing workflow, such as billing for services, evaluating productivity, locating shared resources, etc.

In some examples, the access event detector 108 is able to determine the direction of the access event (e.g., whether the access was an entry or exit). For instance, if the access event detector 108 includes a thermal imager, the thermal imager obtains a sequence of thermal images of the physical access portal (e.g., a sequence of thermal images of a doorway). The thermal imager may be placed such that it is substantially viewing a portal from above, and the field of view of the thermal imager spans the entire portal. In this way a sequence of thermal images combined with appropriate analytic software can determine if there was an access event associated with the building area. Unlike a PIR sensor or a light curtain sensor, the thermal imager can further provide data to determine if the event was an entry event or an exit event. Also, appropriate thermal images and orientation thereof enables the proper detection of simultaneous events such as one person entering the building area while another is leaving the area, generating both an entry event and exit event that may then be correlated to the RTLS position estimates and used to filter out spurious RTLS position estimates.

The access event detector 108 can include a hardware processor to process the thermal images to detect the direction of movement of a person relative to the doorway. For instance, warmer areas in a thermal image are brighter than colder areas. The hardware processor may implement a thresholding algorithm that detects a person in a thermal image by detecting an area in the thermal image that exceeds a brightness threshold. The hardware processor may than determine relative movement of the brighter area in the thermal images to determine if the access was entering the building-area or exiting the building-area. The processing device 106 uses the direction of the access event to confirm the building-area location of the person or object identified by the beacon signal.

In the previous examples, the access event detector 108 used one or more sensors to detect a physical access event and either store the occurrence of the event (e.g., with a timestamp) for retrieval by the processing device 106 or send an indication of the event (e.g., in a message with a timestamp) to the processing device 106. In some examples, the access event detector 108 sends raw sensor information to the processing device 106 and the processing device 106 determines the access event from the raw sensor information.

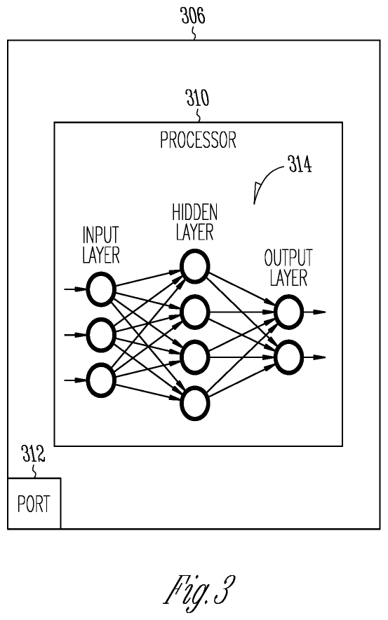

FIG. 3 is a block diagram of an example of portions of a processing device 306. The processing device 306 includes a hardware processor 310 and a port 312 (e.g., a wireless communication port) to receive location information from a receiver device 104 and to receive sensor information (e.g., from an access event detector 108). In some examples, the sensor information is a sequence of thermal images. The processing device 306 uses the thermal image sequence to determine an access event and may determine a direction of the access event. The access event detector 108 may include a thermal imager with a low pixel resolution (e.g., an eight-pixel by eight-pixel (8×8) resolution, a 32×24 resolution, or a 32×32 resolution) and the thermal images are a sequence of low-resolution thermal images. Using low-resolution imaging can be beneficial in maintaining privacy by minimizing the acquisition of personally identifiable information. Also, the data volume of low-resolution images and image sequences is small, allowing less expensive low-bandwidth communication channels to be used to facilitate rapid transmission of the images.

The processor 310 may perform software instructions to implement a neural network 314. The processor 310 inputs the thermal image sequence to an input layer of the neural network 314 to detect an access event in the thermal images and may determine a direction of the access event using the neural network. The neural network 314 may be trained to perform classification. The neural network may be trained to report three classes of events: in-event, out-event, and other. In some examples, the neural network 314 is trained to report four classes of events: in-event, out-event, other, and no object present in the thermal images. The neural network 314 may be a recursive neural network, long short term memory (LSTM) neural network, regression network, or convolutional neural network.

The processor 310 may perform software instructions to implement another approach to detecting an access event and the direction of the access event. For instance, the processor 310 may perform software instructions to implement the thresholding algorithm described previously herein to detect a person in the thermal images, detect an access event in the images, and classify the access event as an in-event, out-event, and other.

The processing device 306 improves RTLS room-level accuracy by associating (e.g., matching) the RTLS building-area location estimates from the beacon signals with access events determined by the thermal imaging. For example, in a hospital environment if the RTLS system has been consistently reporting a patient to be in Room X and then suddenly indicates the patient is in adjacent Room Y, both of which are accessed through a common hallway, the thermal image data can be checked for two events at a similar time: an out-event for Room X and an in-event for Room Y. If both events did not occur, then the RTLS position estimate may be considered a spurious “hop” and ignored. Similarly, if the RTLS system indicates that a staff member left Room X and is in Hallway Z where there is not an access event detector, then a single check for an access event for Room X may be initiated. The thermal image data should indicate an exit event from room X at a similar time as indicated by beacon signals of the RTLS system. If not, the RTLS position estimate can be ignored as spurious.

The functionality of the sensing system can be extended beyond detecting in-events and out-events. As an example, it may be desired to keep track of the number of people in the room using the RTLS system. In this case, a regression neural network may be trained to estimate N in-events and N out-events, where N is the maximum anticipated number of simultaneous events (e.g., two people walking into a room together). If N is sufficiently small, the neural network may be a classification network to estimate 0-in, 1-in, 2-in, . . . 0 out, 1 out, 2 out, etc. The number of people in the room at a particular time can then be estimated from multiple detected portal access events as the running summation of the net number of people entering a room (i.e., the number entering minus the number leaving). Similarly, if it is desired to count the number of people passing through a certain area in each direction, the processing device 306 may use the thermal imaging data to keep a running summation of people going in each of the directions of interest to track the number of people in the room.

The RTLS systems described so far herein use a central processing approach to estimating locations of persons or objects and confirming the estimates using sensors. The processing device 106 in FIG. 1, or processing device 306 in FIG. 3, can be located centrally at the building (or similar structure or location) to receive one or more of identity information, location information, access event information, and sensor information to determine, track, and verify building-area location of persons or objects. Alternatively, a cloud processing approach can be used, and the information is sent to a networked attached device or devices, such as a cloud-based processing device 106 (e.g., a cloud-based server) or devices to determine and confirm building-area location of persons or objects. Any of the various processing of the methods described may be performed by any combination of the processing device, receiver devices, and access event detectors.

Another approach uses edge processing to determine, track, and verify building-area location of persons or objects. In the edge processing approach, the processing to determine location information and the access event detection to confirm the location is performed in a distributed fashion at the building-area locations. In the example of FIG. 1, one or more of the receiver devices 104 and the processing device 106 can be combined into multiple processing devices that are located at the building-area locations of interest. One or more of the access event detectors 108 can also be included in the multiple processing devices of the system that perform edge processing.

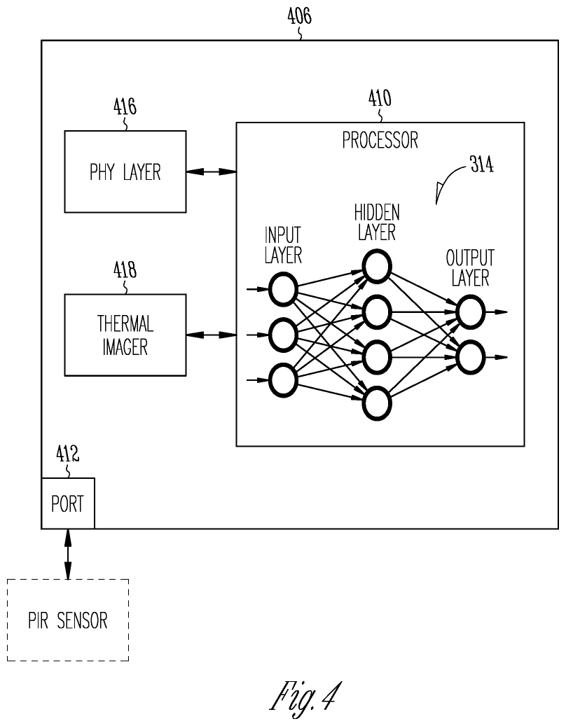

FIG. 4 is a block diagram of another example of portions of a processing device 406. The processing device 406 provides edge processing for RTLS services. The processing device 406 includes at least one hardware processor 410 (e.g., a microprocessor or microcontroller) and physical (PHY) layer circuitry. The PHY layer 416 of the processing device 406 receives the beacon signals from the beacon emitting devices 102. The processor 410 decodes the identifier in a beacon signal and associates the identified object or person with its building-area location. The identification and location information may be sent to a cloud-based device or other central device that collects the location and identification information from the processing devices 406.

The processing device 406 may include an access event detector that provides portal access information that is used to confirm the identification and location information provided by a received beacon signal. In the example of FIG. 4, the processing device 406 includes a thermal imager 418 that provides a sequence of thermal images of a physical access portal. The processing device 406 may be placed above a doorway as a gateway device and can receive beacon signals and process the thermal images of the doorway. The processor 410 performs instructions included in analytical software of the processing device 406 that cause the processor 410 to detect a physical access event in the thermal image sequence. The processor 410 may determine a direction of physical access events using the thermal image sequence and use the direction information to confirm the identification and location information.

In some examples, the analytical software implements a neural network 314. The processor 410 inputs the thermal image sequence into the neural network 314, and the neural network 314 outputs a classification of the portal access event (e.g., as an entry-event, an exit-event, or other event). In some examples, the analytical software implements a blob detection algorithm that further includes thresholding. The processor 410 performs the blob detection algorithm to detect a person in the thermal image sequence and to track the detected person in the thermal image sequence to determine the direction of the physical access event. The processor 410 may also keep track of the number of people in the building-area of interest associated with the processing device 406.

The thermal imager 418 may be a low-resolution thermal imager. In some implementations of an RTLS system, supplying power lines may not possible. The lower power consumption of a low-resolution thermal imager combined with a microcontroller, opens the possibility for battery-operated processing devices 406. Battery operation may be further facilitated and extended by incorporating a subsystem that enables parts of the processing device 406 system to be put into low-power sleep mode when no one is in proximity of the physical access portal. A low power sensing circuit can then be used to wake the system. One example is a PIR sensing circuit. The processing device 406 can include a port 412 (e.g., a communication port) to receive an input from the PIR sensing circuit 420.

When the PIR sensing circuit 420 detects a thermal object, this may be a physical access event. The PIR sensing circuit 420 provides a signal or other indication to the port 412 of the processing device 406. This wakes the rest of the processing device 406 system, which can then acquire and process thermal image sequences to look for physical access events. When the PIR sensing circuit 420 and the thermal imager 418 no longer detect any thermal objects, the processing device 406 can go into the low-power sleep mode, reducing overall power consumption and extending battery life.

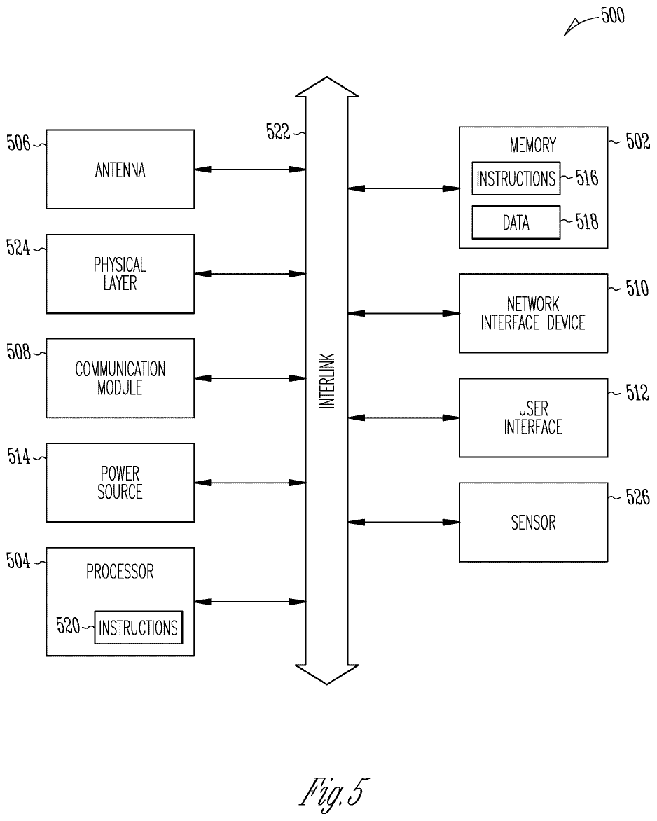

FIG. 5 is a block diagram schematic of various example components for supporting the device architectures described and illustrated herein. The device 500 of FIG. 5 could be, for example, a processing device (e.g., any of the processing devices of FIGS. 1, 3, or 4) that estimates locations of persons or objects, or an access event detector.

At a basic level, a processing device can have an interface (e.g., one or more antennas and Integrated Circuit (IC) chip(s)), that permits the processing device to receive identifier data that identifies the person or object and may provide location information, and sensor data to confirm the identification and location information. With reference specifically to FIG. 5, examples of a device 500 for supporting the device architecture described and illustrated herein may generally include one or more of a memory 502, a processor 504, one or more antennas 506, a communication module 508, a network interface device 510, a user interface 512, and a power source 514 or power supply.

Memory 502 can be used in connection with the execution of application programming or instructions by processor 504, and for the temporary or long-term storage of program instructions or instruction sets 516, as well as any data, data structures, and/or computer-executable instructions needed or desired to support the above-described device architecture. For example, memory 502 can contain executable instructions 516 that are used by the processor 504 to run other components of device 500, to analyze sensor data 518 (e.g., thermal images) to make physical access determinations, to implement a neural network, store confirmed location information, and/or to perform any of the functions or operations described herein, such as the method of FIG. 2 for example. Memory 502 can comprise a computer readable medium that can be any medium that can contain, store, communicate, or transport data, program code, or instructions for use by or in connection with device 500. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer readable media includes, but is not to be confused with, computer readable storage medium, which is intended to cover all physical, non-transitory, or similar embodiments of computer readable media.

Processor 504 can correspond to one or more computer processing devices or resources. For instance, processor 504 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 404 can be provided as a microprocessor, Central Processing Unit (CPU), or plurality of microprocessors or CPUs that are configured to execute instructions sets stored in an internal memory 520 and/or memory 502.

Antenna 506 can correspond to one or multiple antennas and can be configured to provide for wireless communications between device 500 and another device. Antenna(s) 506 can be arranged to operate using one or more wireless communication protocols and operating frequencies including, but not limited to, the IEEE 802.15.1, Bluetooth™, Bluetooth Low Energy (BLE), near field communications (NFC), ZigBee, GSM, CDMA, Wi-Fi, RF, UWB, and the like.

Device 500 may additionally include a communication module 508 and/or network interface device 510. Communication module 508 can be configured to communicate according to any suitable communications protocol with one or more different systems or devices either remote or local to device 500. Network interface device 510 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 510 can include an Ethernet port or other physical jack, a Wi-Fi card, a Network Interface Card (NIC), a cellular interface (e.g., antenna, filters, and associated circuitry), or the like. In some examples, network interface device 510 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 506, communication module 508, and/or network interface device 510 or subcomponents thereof, may be integrated as a single module or device, function or operate as if they were a single module or device, or may comprise of elements that are shared between them.

User interface 512 can include one or more input devices and/or display devices. Examples of suitable user input devices that can be included in user interface 512 include, without limitation, one or more buttons, a keyboard, a mouse, a touch-sensitive surface, a stylus, a camera, a microphone, etc. Examples of suitable user output devices that can be included in user interface 512 include, without limitation, one or more LEDs, an LCD panel, a display screen, a touchscreen, one or more lights, a speaker, etc. It should be appreciated that user interface 512 can also include a combined user input and user output device, such as a touch-sensitive display or the like. Sensor circuit 526 may provide sensor data to detect a physical access event or a signal to wake up one or more components of device 500.

Power source 514 can be any suitable internal power source, such as a battery, capacitive power source or similar type of charge-storage device, etc., and/or can include one or more power conversion circuits suitable to convert external power into suitable power (e.g., conversion of externally supplied AC power into DC power) for components of the device 500. Device 500 can also include one or more interlinks or buses 522 operable to transmit communications between the various hardware components of the device. A system bus 522 can be any of several types of commercially available bus structures or bus architectures.

The systems, methods, and devices described herein can be used to improve accuracy in real time location services. Estimates of the building-area location of people or objects are checked using sensor data. This reduces errors in the real time location services.

### Additional Disclosure and Examples

Example 1 includes subject matter (such as a method of operating a real-time location service (RTLS) system) including obtaining, by a processing device of the RTLS system, location information identifying an object or person and a building-area location of the object or person; obtaining, by the processing device, access-event information of access of a physical access portal associated with the building-area location; and matching the location information of the identified object or person and the access event information and generating an indication of the building-area location of the object or person using the processing device in response to the matching.

In Example 2, the subject matter of Example 1 optionally includes the processing device receiving an indication of the access of the physical access portal from an access detector device that includes one of an infrared (IR) detector, a light curtain, or a thermal imager.

In Example 3, the subject matter of one or both of Examples 1 and 2 optionally includes the processing device receiving information of a direction of the access of the physical access portal from an access detector device that includes a thermal imager.

In Example 4, the subject matter of one or any combination of Examples 1-3 optionally includes the processing device obtaining a sequence of thermal images of the physical access portal and determining a direction of the access of the physical access portal using the thermal image sequence.

In Example 5, the subject matter of Example 4 optionally includes processing circuitry of the processing device performing thresholding to detect a person in the thermal image sequence and tracking the detected person in the thermal image sequence to determine the direction of the access of the physical access portal.

In Example 6, the subject matter of one or both of Examples 4 and 5 optionally includes inputting the thermal image sequence into a neural network implemented by processing circuitry of the processing device, and receiving from the neural network a classification of the access of the physical access portal as one of an entry-event, an exit-event, or other event.

In Example 7, the subject matter of one or any combination of Examples 4-6 optionally includes the processing device tracking a number of people in the building-area location using access event information of multiple accesses of the physical access portal.

In Example 8, the subject matter of one or any combination of Examples 1-7 optionally includes the processing device associated with the building-area location, and the method further including receiving, by the processing device, a beacon signal identifying the object or person, and confirming the building-area location of the identified object or person using the received beacon signal and the access event information.

In Example 9, the subject matter of Example 8 optionally includes receiving an indication of the access of the physical access portal from an access detector device that includes a passive infrared detector (PIR); generating, by the processing device, a sequence of thermal images of the physical access portal in response to the indication of the access; and determining one or both of a direction of the access of the physical access portal using the thermal image sequence, and a number of persons included in the access.

In Example 10, the subject matter of Example 9 optionally includes the processing device generating a sequence of thermal images that have a resolution of equal to or less than thirty-two pixels by thirty-two pixels.

Example 11 can include subject matter (such as a real-time location services (RTLS) system) or can optionally be combined with one or any combination of Examples 1-10 to include such subject matter, including a processing device including at least one hardware processor operatively coupled to the physical layer circuitry and memory. The memory to store instructions that cause the at least one hardware processor to perform operations including receiving location information identifying an object or person and a building-area location of the object or person from a receiver device of the system, receiving access-event information of access of a physical access portal associated with the building-area location from an access detector device of the system, and matching the location information of the identified object or person and the access-event information and generating an indication of the building-area location of the object or person in response to the matching.

In Example 12, the subject matter of Example 11 optionally includes multiple receiver devices configured to receive beacon signals identifying objects or people, each receiver device associated with at least one building-area location; and multiple access detector devices. Each access detector device configured to detect access of a physical access portal associated with the at least one building-area location of a receiver device.

In Example 13, the subject matter of one or both of Examples 11 and 12 optionally includes the memory storing instructions that cause the at least one hardware processor to receive information of a direction of the access of the physical access portal from the access detector device; and match the building-area location of the identified object or person using the direction of the access.

In Example 14, the subject matter of one or any combination of Examples 11-13 optionally includes the memory storing instructions that cause the at least one hardware processor to receive a sequence of thermal images of the physical access portal, determine a direction of the access of the physical access portal using the thermal image sequence, and confirm the building-area location of the identified object or person using the direction of the physical access event.

In Example 15, the subject matter of Example 14 optionally includes the memory storing instructions that cause the at least one hardware processor to apply a thresholding detection algorithm to the thermal image sequence to detect a person in the sequence of thermal images; and track position of the detected person in the thermal image sequence to determine the direction of the access of the physical access portal.

In Example 16, the subject matter of one or both of Examples 14 and 15 optionally includes the memory storing instructions that cause the at least one hardware processor to input the thermal image sequence into a neural network implemented by processing circuitry of the processing device; and output a classification from the neural network of the access of the physical access portal as one of an entry-event, an exit-event, or other even.

In Example 17, the subject matter of one or any combination of Examples 11-16 optionally includes the memory storing instructions that cause the at least one hardware processor to receive information of multiple accesses of the physical access portal, and track a number of people in the building-area location using information of the multiple accesses.

Example 18 includes subject matter (such as a processing device for a real-time location service (RTLS) system) or can optionally be combined with one or any combination of Examples 1-17 to include such subject matter, including physical layer circuitry configured to receive a beacon signal; at least one hardware processor operatively coupled to the physical layer circuitry; and a memory. The memory to sore instructions that cause the at least one hardware processor to perform operations including decoding an identifier in the beacon signal that identifies an object or person, associating the identified object or person with a building-area location associated with the processing device, obtaining access-event information of access of a physical access portal associated with the building-area location, matching the building-area location of the object or person using the access-event information, and generating an indication of the building-area location of the identified object or person in response to the matching.

In Example 19, the subject matter of Example 18 optionally includes a thermal imager configured to produce a sequence of thermal images of the physical access portal, wherein the memory stores instructions that cause the at least one hardware processor to determine a direction of the access of the physical access portal using the thermal image sequence, and confirm the building-area location of the object or person using the determined direction of the physical access event.

In Example 20, the subject matter of one or both of Examples 18 and 19 optionally includes a communication port configured to receive an indication of the access of the physical access portal from a separate device, and the thermal imager is configured to produce the sequence of thermal images of the physical access portal in response to receiving the indication of the access.

In Example 21, the subject matter of one or both of Examples 19 and 20 optionally includes a thermal imager that produces a sequence of thermal images that have a resolution of less than thirty-two pixels by thirty-two pixels In Example 22, the subject matter of one or any combination of Examples 19-21 optionally includes the memory storing instructions that cause the at least one hardware processor to perform a thresholding algorithm to detect a person in the thermal image sequence and to track the detected person in the thermal image sequence to determine the direction of the access of the physical access portal.

In Example 23, the subject matter of one or any combination of Examples 19-22 optionally includes the memory storing instructions that cause the at least one hardware processor to input the thermal image sequence into a neural network implemented by the at least one hardware processor, and output a classification by the neural network of the access of the physical access portal as one of an entry-event, an exit-event, or other event.

These non-limiting Examples can be combined in any permutation or combination. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A method of operating a real-time location services (RTLS) system, the method comprising:
obtaining, by a processing device of the RTLS system, location information identifying an object or person and a building-area location of the object or person;
obtaining, by the processing device, access-event information of access of a physical access portal associated with the building-area location; and
matching the location information of the identified object or person and the access event information and generating an indication of the building-area location of the object or person using the processing device in response to the matching.

2. The method of claim 1, wherein the obtaining the access-event information includes the processing device receiving an indication of the access of the physical access portal from an access detector device that includes one of an infrared (IR) detector, a light curtain, or a thermal imager.

3. The method of claim 1, wherein the obtaining the access-event information includes the processing device receiving information of a direction of the access of the physical access portal from an access detector device that includes a thermal imager.

4. The method of claim 1, wherein the obtaining the access-event information includes the processing device obtaining a sequence of thermal images of the physical access portal and determining a direction of the access of the physical access portal using the thermal image sequence.

5. The method of claim 4, wherein the obtaining the access-event information further includes processing circuitry of the processing device performing thresholding to detect a person in the thermal image sequence and tracking the detected person in the thermal image sequence to determine the direction of the access of the physical access portal.

6. The method of claim 4, wherein the obtaining the access-event information further includes:
inputting the thermal image sequence into a neural network implemented by processing circuitry of the processing device; and
receiving from the neural network a classification of the access of the physical access portal as one of an entry-event, an exit-event, or other event.

7. The method of claim 4, including the processing device tracking a number of people in the building-area location using access event information of multiple accesses of the physical access portal.

8. The method of claim 1,
wherein the processing device is associated with the building-area location and wherein the obtaining the location information identifying an object or person includes receiving, by the processing device, a beacon signal identifying the object or person; and
wherein the matching the building-area location includes confirming the building-area location of the identified object or person using the received beacon signal and the access event information.

9. The method of claim 8, wherein the obtaining the access-event information includes:
receiving an indication of the access of the physical access portal from an access detector device that includes a passive infrared detector (PIR);
generating, by the processing device, a sequence of thermal images of the physical access portal in response to the indication of the access; and
determining one or both of a direction of the access of the physical access portal using the thermal image sequence, and a number of persons included in the access.

10. The method of claim 9, wherein generating the sequence of thermal images includes
the processing device generating a sequence of thermal images that have a resolution of equal to or less than thirty-two pixels by thirty-two pixels.

11. A real-time location services (RTLS) system, the system comprising:
a processing device including at least one hardware processor operatively coupled to the physical layer circuitry; and
a memory storing instructions that cause the at least one hardware processor to perform operations including:
receiving location information identifying an object or person and a building-area location of the object or person from a receiver device of the system;
receiving access-event information of access of a physical access portal associated with the building-area location from an access detector device of the system; and
matching the location information of the identified object or person and the access-event information and generating an indication of the building-area location of the object or person in response to the matching.

12. The system of claim 11 including:
multiple receiver devices configured to receive beacon signals identifying objects or people, each receiver device associated with at least one building-area location; and
multiple access detector devices, each access detector device configured to detect access of a physical access portal associated with the at least one building-area location of a receiver device.

13. The system of claim 11, wherein the memory stores instructions that cause the at least one hardware processor to:
receive information of a direction of the access of the physical access portal from the access detector device; and
match the building-area location of the identified object or person using the direction of the access.

14. The system of claim 11, wherein the memory stores instructions that cause the at least one hardware processor to:
receive a sequence of thermal images of the physical access portal;
determine a direction of the access of the physical access portal using the thermal image sequence; and
confirm the building-area location of the identified object or person using the direction of the physical access event.

15. The system of claim 14, wherein the memory stores instructions that cause the at least one hardware processor to:
apply a thresholding detection algorithm to the thermal image sequence to detect a person in the sequence of thermal images; and
track position of the detected person in the thermal image sequence to determine the direction of the access of the physical access portal.

16. The system of claim 14, wherein the memory stores instructions that cause the at least one hardware processor to:
input the thermal image sequence into a neural network implemented by processing circuitry of the processing device; and
output a classification from the neural network of the access of the physical access portal as one of an entry-event, an exit-event, or other event.

17. The system of claim 11, wherein the memory stores instructions that cause the at least one hardware processor to:
receive information of multiple accesses of the physical access portal; and
track a number of people in the building-area location using information of the multiple accesses.

18. A processing device for a real-time location service (RTLS) system, the processing device comprising:
physical layer circuitry configured to receive a beacon signal;
at least one hardware processor operatively coupled to the physical layer circuitry; and
a memory storing instructions that cause the at least one hardware processor to perform operations including:
decoding an identifier in the beacon signal that identifies an object or person;
associating the identified object or person with a building-area location associated with the processing device;
obtaining access-event information of access of a physical access portal associated with the building-area location;
matching the building-area location of the object or person using the access-event information; and
generating an indication of the building-area location of the identified object or person in response to the matching.

19. The processing device of claim 18, including:
a thermal imager configured to produce a sequence of thermal images of the physical access portal;
wherein the memory stores instructions that cause the at least one hardware processor to determine a direction of the access of the physical access portal using the thermal image sequence; and
confirm the building-area location of the object or person using the determined direction of the physical access event.

20. The processing device of claim 19, including:
a communication port configured to receive an indication of the access of the physical access portal from a separate device; and
wherein the thermal imager is configured to produce the sequence of thermal images of the physical access portal in response to receiving the indication of the access.

21. The processing device of claim 19, wherein the thermal imager produces a sequence of thermal images that have a resolution of less than thirty-two pixels by thirty-two pixels.

22. The processing device of claim 19, wherein the memory stores instructions that cause the at least one hardware processor to perform a thresholding algorithm to detect a person in the thermal image sequence and to track the detected person in the thermal image sequence to determine the direction of the access of the physical access portal.

23. The processing device of claim 19, wherein the memory stores instructions that cause the at least one hardware processor to:
input the thermal image sequence into a neural network implemented by the at least one hardware processor; and
output a classification by the neural network of the access of the physical access portal as one of an entry-event, an exit-event, or other event.
